(19) United States
(12) Patent Application Publication
(10) Pub. No.: US 2025/0091803 A1
(43) Pub. Date: Mar. 20, 2025

(54) REFUSE COLLECTION SYSTEM, CONTROL UNIT THEREFOR, AND METHOD

(71) Applicant: Mr. Fill Holding B.V., CULEMBORG (NL)

(72) Inventor: Jacob Joost LUINSTRA, CULEMBORG (NL)

(73) Assignee: Mr. Fill Holding B.V., CULEMBORG (NL)

(21) Appl. No.: 18/727,254

(22) PCT Filed: Jan. 16, 2023
(86) PCT No.: PCT/EP2023/050862

§ 371 Date: Jul. 8, 2024

(30) Foreign Application Priority Data
Jan. 17, 2022 (NL) 2030570
Jul. 1, 2022 (NL) 2032352

(51) Int. Cl. B65F 1/14; H02J 7/35

(52) U.S. Cl. CPC B65F 1/14; H02J 7/35; H02J 2207/20; H02J 2300/26

(57) ABSTRACT

A refuse collection system having a maximum power point tracker includes a DC-DC converter. The DC-DC converter is electrically connected at a first output thereof to one or more photovoltaic panels of the system, and at second output thereof to one or more batteries for being charged by the photovoltaic panels. The maximum power point tracker is configured to increase the power output of the photovoltaic panels towards, e.g. to set this power output to, the maximum power point thereof, therein adjusting a current at which the batteries are charged. A control unit of the system, programmed to control electrically powered functional parts of the system, is preferably furthermore programmed to control the DC-DC converter.

The present invention relates to the field of collecting refuse, wherein refuse is collected in a collection container, in particular to providing a refuse collection system equipped with such collection container with electrical power from a solar panel.

### FIELD OF THE INVENTION

Refuse collection systems, e.g. as disclosed in EP3265303, WO2021013555 and WO2019221605 are known to be supplied with electricity by one or more photovoltaic panels, i.e. panels of solar cells, in order for the system to be partly or entirely independent from energy supply by the grid. Preferably, the photovoltaic panels are sized in order for the system to be autonomous, i.e. not connected to the electricity grid, which increases the range of possible placement locations, and may ease installation, maintenance and even the emptying processes, e.g. where such emptying involves hoisting underground containers from a pit, as no account has to be taken anymore of the associated cabling. Such solar-powered refuse collection systems are equipped with one or more batteries, which store electric energy generated by the solar panels. The one or more batteries provide power for specific electronic, i.e. electrically powered, functional parts of the refuse collection system which are involved with the collection of refuse. For example, such functional parts include one or more of sensoring, a control unit, a user interface, a communication interface for communication with an external server, and actuators, e.g. for operating moving parts such as a door which grants or blocks access to a refuse insert opening, a receiving device for receiving refuse, a transportation device for transporting received refuse, a distribution device for distributing refuse received through the insert opening, a compacting device for compacting collected refuse in a storage container, and other mechanisms for processing and storing refuse, e.g. actuators producing light or sound, e.g. an alarm signal.

The power rating of the photovoltaic panels of refuse collection systems is generally relatively low, e.g. in the order of several tenths of Watts, e.g. 20 Watts. Very large systems may be provided with panels rated at up to 400 Watts.

According to the state of the art, the photovoltaic panels are directly connected to the battery for charging thereof. Expectations on power outputs of the panels during the year, e.g. therein taking account of the local climate conditions, including irradiation, at the placement location, may be used to size the battery in order to reach the corresponding charging voltage of the battery, which is during operation imposed on the photovoltaic panels. For example, at a moderate latitude, a solar panel of 20 Watts having a maximum voltage of 21 Volts is connected to a battery having a charging voltage of 10 Volts, to match the median expected power output. This approach has, owing to its simplicity, important benefits in terms of robustness, i.e. because of minimal electrical connections, and electric parts, and in terms of costs and space usage for the energy supply in the system. All three factors are often crucial in a competitive market, wherein municipalities strive to maximize possibilities and ease for inhabitants for refuse collection to stimulate clean streets, in the most economical way possible-firstly in terms of costs, e.g. to keep taxes low, and secondly in terms of the space occupation in the public space.

### BACKGROUND OF THE INVENTION

In an effort to reach further improvements relating to robustness, costs and space usage, the present invention aims to provide a further optimized solution, based on a realization that these may be achieved despite an involved sacrifice of the simplicity. Thereby the present invention overcomes the prevailing resistance in the field of technology of employing more complex solutions for energy supply into refuse collection systems so as to not detract from the mentioned benefits.

### SUMMARY OF THE INVENTION

The present invention provides a refuse collection system comprising a refuse collection assembly, an energy supply unit, and a control unit.

The refuse collection assembly comprises:
a refuse collection container,
a housing, having an introduction opening allowing a user to introduce refuse therein, e.g. provided with an introduction device, e.g. a drum type introduction device, so that the introduced refuse drops into the container, and
one or more electrically powered functional parts of the refuse collection system which are involved with the collection of the refuse.

The energy supply unit comprises:
one or more photovoltaic panels, arranged for capturing solar irradiation, and producing a current at a voltage thereover, and
one or more batteries, electrically connected to the photovoltaic panels for being charged thereby.
   the energy supply unit is operatively connected to the one or more electrically powered functional parts for supplying these functional parts with electrical energy.

The control unit is operatively connected to the one or more functional parts and is programmed for control of the one or more functional parts of the refuse collection system by the control unit.

The refuse collection system further comprises, according to the invention, a maximum power point tracker comprising a DC-DC converter, the DC-DC converter being electrically connected at a first output thereof to the one or more photovoltaic panels, and at second output thereof to the one or more batteries.

The maximum power point tracker is configured and connected to the batteries and photovoltaic panels for increasing the power output of the photovoltaic panels towards, e.g. to set this power output to, the maximum power point (MPP) thereof, by, e.g. continuously or at regular intervals, adjusting the current produced by, and/or the voltage over, the solar panels towards the maximum power point, therein adjusting a current at which the batteries are charged by the photovoltaic panels via the DC-DC converter such that it corresponds to the increased power output of the photovoltaic panels.

This refuse collection system adds to the known system configuration a maximum power point tracker (MPPT). Maximum power point trackers are known in the art for use with residential photovoltaic systems, wherein the electrical sink of the system is formed by both a battery and the electricity grid for feeding-back electrical energy thereto, e.g. when the battery is sufficiently charged. Maximum power point trackers act between the electrical sink and the photovoltaic panels, and adjust the current at which the electricity produced by the photovoltaic panels are fed to the sink at the battery-side of the tracker in order to increase the product of the current produced by the photovoltaic panels and the voltage thereover at the side of the tracker of the photovoltaic panels, and thereby, the power output of the photovoltaic panels. Thereby, the MPPT aims to push the operation of the photovoltaic panels towards the maximum power point (MPP) thereof, which is formed by a top in a voltage-power curve thereof. This increases the actual efficiency of the operation photovoltaic panels, wherein the efficiency is maximal at the MPP. The MPPT includes converters for converting the direct current of the photovoltaic panels at the voltage thereover to the direct and alternating current at the charging and feeding-back voltages required by the battery and the grid, respectively.

The maximum power point tracker (MPPT) of the inventive refuse collection system comprises a DC-DC converter. This converter suffices for the application, as, as is known for refuse collection systems, a direct-current battery is used as the electric sink of the photovoltaic panels. Other functional parts generally operate on direct current as well. The DC-DC converter is electrically connected at a first output thereof to the one or more photovoltaic panels of the system, and at second output thereof to the one or more batteries. The addition of the DC-DC converter of the MPPT to the system enables that the photovoltaic panels may operate at a different voltage than the charging voltage of the battery.

In an autonomous system, i.e. without grid connection, the photovoltaic panels and batteries form the only energy supply. The functional parts, and the control unit, are connected directly to the batteries of the energy supply unit, therein discharging the battery when consuming energy during operation, and/or directly to the output of the DC-DC converter. For example, at least the control unit is connected to the output of the DC-DC converter. For example, the tracking also involves adjustment of the current of any other part connected to the output of the DC-DC converter.

When a grid connection is used in addition to the batteries, an AC-DC converter may be employed in the system in addition to the DC-DC converter. For example, the DC-output is, e.g. additionally, connected to one or more of the functional parts and/or the battery.

The MPPT is configured to increase the power output of the photovoltaic panels towards the maximum power point (MPP) thereof. The MPPT may even be configured to set the power output to the MPP. Therein, the MPPT adjusts the current at which the batteries are charged by the photovoltaic panels via the DC-DC converter, i.e. the charging current. This adjustment changes the load of the sink of the photovoltaic panels while the charging voltage of the battery remains constant, so that a different power output, and thus a different combination of current and voltage, is imposed at the panel side of the DC-DC converter. This pushes the point along the actual voltage-power curve of the photovoltaic panels at which the panels operate towards or even to the MPP, improving or even maximizing efficiency, respectively. The MPPT includes a controller to control the adjustments such that these are effective for MPP tracking.

Whereas the addition of the MPPT to the system may complicate the system, and require more electrical parts and connections, its effect on the efficiency of the energy production may be substantial. This may enable to downscale the parts of the energy supply unit, e.g. both the photovoltaic panels and the batteries, which in turn may lead to substantial savings in terms of costs and space usage by this unit, to counterbalance these investments.

The inventors have furthermore realized that the increased complexity and addition of parts entailed by the addition of the MPPT to the system can remain limited by making use of the control unit thereof in a smart way-this control unit after all already being present in the prior art system for controlling the functional parts involved with the collection of refuse. In particularly preferred embodiments, therefore, the control unit is deployed to further reduce the complexity and addition of parts. The control unit may e.g. be used for control of the mentioned adjustments for moving towards the MPP, e.g. such that a simpler additional controller may suffice for the DC-DC conversion in the MPPT, or such that an additional controller is obviated entirely.

An operative interconnection between the DC-DC converter and the control unit, or an integration of the DC-DC converter therein, enables the control unit to extract information on actual operational parameters of the energy unit. For example, values of currents and voltages may be used to improve the functionality of the functional parts of the system involved with the collection of refuse. For example, the operation of these parts may be attuned by the software module on these values. For example, a power by which a compaction device compacts collected refuse may be attuned to the actual power output of the panels.

Furthermore, the presence of the control unit may be turned to the advantage of the system by furthermore utilizing it to further improve the tracking functionality, e.g. the quality of the tracking, so as to further optimize the energy yield from the solar panels, and/or the speed of the tracking, and active and idle times thereof, e.g. to reduce the energy used by the tracking itself. It is furthermore possible to gather data on the operational parameters of the energy unit, and store these in a memory portion of the software module, so that these can be used to the advantage of the system. For example, data on voltage-current and/or voltage-power relationships at different conditions can be used to make predictions on the availability of energy in the near future, so that the control unit can anticipate thereon by adjusting the control of the operation of the functional parts thereby.

Such further improvements relating to energy supply, and advantages relating to the specific purpose-related functionalities of the system involved with refuse collection, in conjunction with the control unit cannot be made with the static system according to the prior art. In that sense, the addition of the MPPT thus opens up additional possibilities for the system. In the inventive system the tracking can, e.g. by the configuration of the MPPT and/or by means of the configuration of the control unit, be specifically adapted to the characteristics, e.g. including the rated power, of the photovoltaic panel(s) applied in the specific system. For example, the known trackers are suited to residential systems at a relatively high rated power, and may as such lack sufficient sensitivity to effectively perform meaningful tracking when connected to a panel rated at several tenths of watts, as may be applied in refuse collection containers.

In an example, the tracking can by means of the control unit be specifically adapted, e.g. dynamically based on one or more actual conditions, to the expected energy demand by the system. For example, during periods of time at which the system is purposely closed for use, e.g. during a turn-of-the-year, or a maintenance state, the sink for the electricity production by the photovoltaic panel will exclude some functional electric parts, such as receiving, distribution and/or compaction devices, sensors measuring characteristics of refuse being processed, e.g. the weight of received refuse and/or the filling level of the container, and a user interface, e.g. including e.g. an identification reader. At periods of time wherein the system is expected to be used extensively, particularly when irradiation is also low, battery charging will be more limited whereas the demand by the mentioned functional electric parts will be high. The tracking may e.g. be controlled to be more or less frequent or accurate to suit these different conditions and demands. Or to be done by different means-for example utilizing different algorithms which require more or less energy, wherein the algorithm is chosen based on the conditions and demands.

Furthermore, the presence of the control unit enable embodiments wherein the MPPT is partially or entirely integrated in the control unit. This facilitates convenient operative interconnections-e.g. availability of actual operative parameters and conditions of the DC-DC converter and the parts connected thereto within the control unit itself, for example a measurement of the produced current at the first output of the DC-DC converter by means of an ammeter also integrated in the control unit.

In an embodiment the control unit is furthermore programmed to control the DC-DC converter. In this or an alternative embodiment the maximum power point tracker (MPPT) is partially or entirely integrated in the control unit.

In an embodiment the control unit further comprises a software module, e.g. a software chip, which is operatively connected to the DC-DC converter, and contains
programming for the control of the one or more functional parts of the refuse collection system, and
programming for controlling the operation of the DC-DC converter by the control unit.

In an embodiment the control unit is programmed to execute, e.g. the programming for control of the operation of the DC-DC converter contained by the software module of the control unit contains, an algorithm controlling the DC-DC converter such as to adjust the voltage over and/or current produced by the photovoltaic panels, therein adjusting the charging current of the batteries.

In an embodiment the control unit is programmed to execute, e.g. the programming for control of the operation of the DC-DC converter contained by the software module of the control unit contains, an algorithm for determining a value of the voltage over the photovoltaic panels and/or of the charging current of the batteries that differs from the actual respective voltage and/or current and is involved with an increase of the power output of the photovoltaic panels, e.g. to the maximum power point thereof.

In an example of this embodiment, the control unit, e.g. the software module thereof, is furthermore programmed to, via the operative connection to the DC-DC converter, communicate the different value of the respective voltage and/or current to the DC-DC converter. In another example the control unit, e.g. the software module thereof, is furthermore programmed to control the DC-DC converter such as to adjust the voltage over the photovoltaic panels and/or the charging current of the batteries to the determined respective different value of the voltage and/or current. In an example wherein the control unit is furthermore programmed to control the DC-DC converter, the control unit for example comprises the DC-DC converter, e.g. comprises the maximum power point tracker. Therein the control unit is at a first output thereof electrically connected to the photovoltaic panels, via the first output of the DC-DC converter of the maximum power point tracker, and at a second output thereof connected to the batteries, via the second output of the DC-DC converter. In an example, the maximum power point tracker further comprises the programming of the control unit for controlling the operation of the DC-DC converter, e.g. comprises the software module.

In an example, the algorithm for determining the mentioned different value of the voltage over the photovoltaic panels and/or of the charging current comprises determining from a voltage-power curve of the photovoltaic panels over at least a part of the voltage range thereof, the different value of the voltage as the voltage which corresponds to the highest power output of the curve, e.g. wherein the voltage-power curve extends over the entire voltage range of the photovoltaic panels, and the different value of the voltage corresponds to the voltage at the maximum power point (MPP) of the photovoltaic panels. The voltage-power curve from which the different value of the voltage is determined may therein be stored, e.g. on the control unit, e.g. in a memory portion of the software module, in the form of data on the power output in association with values of voltages over the photovoltaic panels distributed along the voltage range of the photovoltaic panels. In another example the voltage-power curve from which the different value of the voltage is determined, is an actual voltage-power curve of the photovoltaic panels, wherein the algorithm for determining the different value of the voltage over the photovoltaic panels and/or of the charging current further comprises, prior to the determination of the different value of the voltage over the photovoltaic panels and/or of the charging current, determining the actual voltage-power curve.

The actual current being generated by the one or more photovoltaic panels may be monitored by the control unit. For example, the control unit disables the maximum power point tracking, e.g. the MPPT, in case the actual current generated by the one or more photovoltaic panels is below a threshold value-so that the one or more batteries are then charged directly by the one or more photovoltaic panels without involvement of the DC-DC converter of the MPPT. This approach, for example, can be of benefit in the situation that the actual current being generated by the photovoltaic panels is less than the energy consumption of the MPPT itself. In this case, the direct charging of the batteries without the use of the MPPT is more effective. For example, the control unit thereto operates a switch for bypassing the DC-DC converter. For example, in a practical embodiment, the threshold value for the current could be 8-12 mA, e.g. 10 mA.

The control unit may be configured to disable the charging of the batteries while the batteries are fully charged, and to resume charging as soon as the batteries are charged to below a threshold value, the control unit thereto being operatively connected to the batteries for determining the charge level of the batteries.

In an embodiment the system further comprises an ammeter, electrically connected to the photovoltaic panels, and configured for producing a signal indicative of the actual current produced by the photovoltaic panels, for use by the control unit in the control of the system, e.g. including the control of the DC-DC converter, e.g. the ammeter being operatively connected to the software module of the control unit for communicating the signal to the software module. In an example, the programming comprises disabling the maximum power point tracking, e.g. tracker (MPPT), in case the actual current produced by the photovoltaic panels is below a threshold value so that the one or more batteries are then charged directly by the one or more photovoltaic panels without involvement of the DC-DC converter of the maximum power point tracker (MPPT), e.g. by operating a switch for bypassing the DC-DC converter, e.g. wherein the threshold value is between approximately 8 and 12 mA, e.g. 10 mA.

In an embodiment, the maximum power point tracker (MPPT) comprises the earlier mentioned ammeter, and the determination of the different value of the voltage and/or current by the algorithm in the software module is based on the measured current, e.g. in the programming of the software module for controlling the DC-DC converter.

In a particular embodiment, the determination of the actual voltage-power curve of the photovoltaic panels by the algorithm in the software unit comprises the following steps:
1) controlling the DC-DC converter such as to adjust the voltage over the photovoltaic panels,
2) determining the power output at the adjusted voltage by multiplying the value of the adjusted voltage with the measured value of the current produced by the photovoltaic panels at the adjusted voltage communicated to the software module by the ammeter,
3) storing the value of the power output in association with the value of the adjusted voltage, e.g. on the control unit, e.g. in the memory portion of the software module,
4) repeating the steps 1), 2) and 3) such that multiple, e.g. at least 10, e.g. at least 100, values of the power output are stored in association with values of voltages distributed over the at least a part of the voltage range of the photovoltaic panels, e.g. the entire voltage range of the photovoltaic panels.

The control unit, e.g. the memory portion of the software module, may have stored therein voltage-power curves of the photovoltaic panels for different respective conditions of the photovoltaic panels which have an influence on the voltage-power relationship of the photovoltaic panels, for example for different temperatures and/or solar irradiation values, each voltage-power curve being stored in the form of data on values of the power output in association with values of voltages over the photovoltaic panels distributed along the voltage range of the voltage-power curve. Therein the system further comprises one or more sensors each configured for producing a respective signal indicative of one or more of the actual conditions of the photovoltaic panels, and operatively connected to, e.g. the software module of, the control unit for communicating the signal to the control unit, e.g. software module, e.g. the sensors comprising a temperature sensor and/or an irradiation sensor provided at or near the photovoltaic panels.

Therein, the actual voltage-power curve of the photovoltaic panels is according to a first manner, determined from the stored voltage-power curves for the different conditions based on the communicated indications by the one or more sensors, e.g. through interpolation between the data for the curves for two successive values of the conditions, or according to a second manner, by executing the above mentioned steps 1) to 4),

For example, the manner of determining the actual voltage-power curve may be chosen by the algorithm based on
actual conditions of the photovoltaic panels, as indicated by the sensors, e.g. wherein the second manner is applied when the actual conditions are outside the range of the conditions for which the curves are stored in the control unit, e.g. the memory portion, or when interpolation would have to take place between values that differ more than a reference value, and/or
a charge level of the batteries, e.g. wherein the second manner is applied only when the charge level is above a reference value.

The power output and voltage may in the execution of steps 1) to 4) be stored as a voltage-power curve in association with the actual conditions of the photovoltaic panels as indicated by the one or more sensors.

In an embodiment the actual voltage-power curve of the photovoltaic panels is determined by the control unit, e.g. the programming of the software module for controlling the DC-DC converter, if triggered by
the lapse of a period of time since the last determination of the actual voltage-power curve,
a change in the conditions of the photovoltaic panels measured by the sensors, e.g. irradiation and/or temperature, in case the change exceeds a reference value within a time period of a predetermined duration from the last determination of the actual voltage-power curve,
a detection by a visual sensor of a shadow being cast or an object being present on a capturing surface of the photovoltaic panels, and/or
the dawning of a predetermined time of day, e.g. wherein the determination of the actual voltage-power curves is executed only during daytime, e.g. the daytime being stored in the control unit, e.g. the memory portion of the software module, based on the actual day of the year, or the daytime being detected based on one or more of the conditions of the photovoltaic panels measured by the sensors, e.g. light intensity and/or irradiation.

The invention furthermore relates to a control unit, suitable for use in a refuse collection system. The refuse collection system may be embodied as described herein as the system according to the invention-and the control unit may be embodied as described herein in relation to this system.

The control unit is configured for operative connection to the one or more functional parts and to the DC-DC converter of the system, and is programmed:
for control of the one or more functional parts of the refuse collection system by the control unit, and
for controlling the operation of the DC-DC converter.

In a embodiment the control unit comprises a software module, e.g. one or more software chips, containing:
programming for control of the one or more functional parts of the refuse collection system by the control unit, and
programming for controlling the operation of the DC-DC converter.

The software module is configured for operative connection to the functional parts and to the DC-DC converter.

In an embodiment the control unit, e.g. the software module thereof, is furthermore programmed to monitor the actual current produced by the one or more photovoltaic panels via an operative connection to an ammeter which is electrically connected to the photovoltaic panels, and configured for producing a signal indicative of the actual current produced by the photovoltaic panels. In an example the programming comprises disabling the maximum power point tracking, e.g. tracker (MPPT), in case the signal indicates that the actual current produced by the photovoltaic panels is below a threshold value so that the one or more batteries are then charged directly by the one or more photovoltaic panels without involvement of the DC-DC converter of the maximum power point tracker, e.g. by operating a switch for bypassing the DC-DC converter, e.g. wherein the threshold value is between approximately 8 and 12 mA, e.g. 10 mA.

In an embodiment the control unit comprises the DC-DC converter, e.g. comprises the maximum power point tracker (MPPT).

The invention furthermore relates to methods for collecting refuse wherein use is made of the control unit, for collecting refuse wherein use is made of a refuse collection system, and for powering a refuse collection system. In embodiments, these methods implement one or more possibilities discussed in relation to the system according to the invention, e.g. in relation to the control unit, e.g. steps of algorithms.

In a method for powering a refuse collection system, the method comprises:
providing an energy supply unit comprising one or more photovoltaic panels, and one or more batteries, electrically connected via a DC-DC converter to the photovoltaic panels for being charged thereby,
charging the one or more batteries by the photovoltaic panels,
supplying the one or more functional parts of the refuse collection system which are involved with the collection of the refuse with electrical energy by means of the energy supply unit, and
providing maximum power point tracking, wherein the maximum power point tracking increases via the DC-DC converter, the power output of the photovoltaic panels towards, e.g. sets this power output to, the maximum power point thereof, by, e.g. continuously or at regular intervals, adjusting the current produced by, and/or the voltage over, the solar panels towards the maximum power point, therein adjusting a current at which the batteries are charged by the photovoltaic panels via the DC-DC converter such that it corresponds to the increased power output of the photovoltaic panels.

The maximum power point tracking may be controlled by a control unit of the refuse collection system. The maximum power tracking may at least partly be provided by programming of the control unit, e.g. wherein the control unit comprises the DC-DC converter, e.g. comprises a maximum power point tracker.

In an embodiment the method further comprises monitoring a current produced by the photovoltaic panels, wherein the maximum power point tracking is provided only in case the actual current produced by the photovoltaic panels is equal to or above a threshold value, so that in case the actual current is below this threshold value, the one or more batteries are charged directly by the one or more photovoltaic panels without involvement of the DC-DC converter of the maximum power point tracker, e.g. wherein the threshold value is between approximately 8 and 12 mA, e.g. 10 mA.

### BRIEF DESCRIPTION OF THE DRAWINGS

The invention is hereinafter described with reference to the appended figures. Therein:

FIG. 1 shows a scheme of electrical and data connections between parts of a system according to the invention,

FIGS. 2a-b illustrate, schematically, the physical appearance of an embodiment of a system according to the invention, respectively in a perspective front-side view and a front view,

FIGS. 3a-b illustrate, schematically in perspective front-side-top views, the physical appearance of another embodiment of a system according to the invention,

FIG. 4a is a graph of typical voltage-current curves of a solar panel at five different irradiation levels,

FIG. 4b is a graph of typical voltage-power curves of a solar panel at the same five different irradiation levels,

FIG. 4c is a graph of typical voltage-power curves of a solar panel at five different temperatures.

### DETAILED DESCRIPTION OF EMBODIMENTS

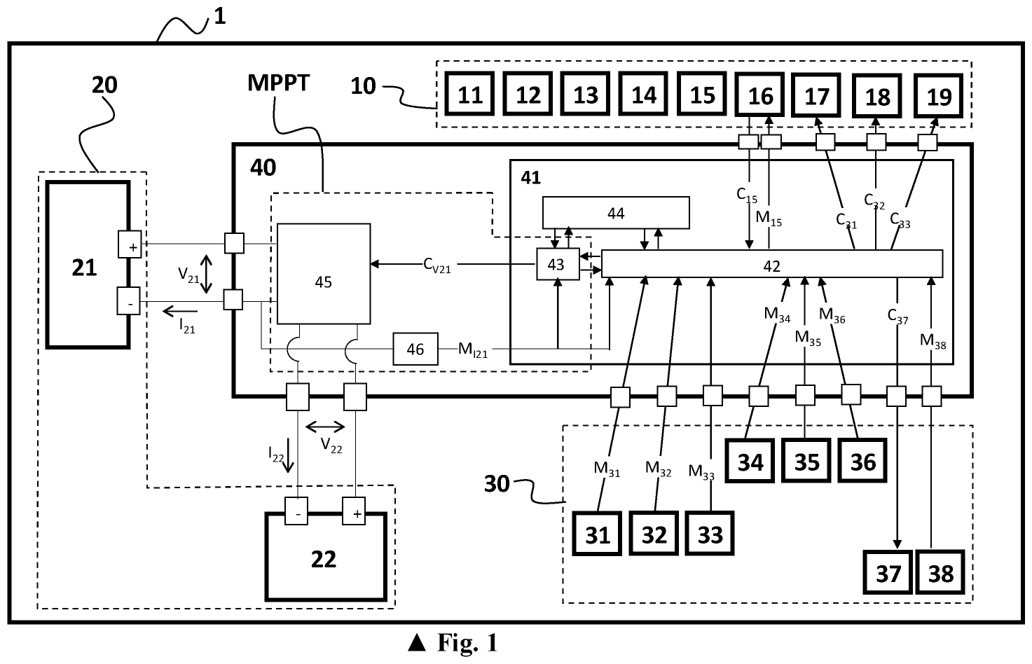

FIG. 1 schematically depicts an embodiment of a system 1 according to the invention. It shows the different parts of the system by means of blocks, and interconnections therebetween by means of lines. Some of these lines represent electrical connections, others represent data connections.

The system 1 is shown by means of striped outlines inside the outline of the system 1, to comprise a refuse collection assembly 10, an energy supply unit 20, a group 30 of electrically powered parts which are, together with the parts of the refuse collection assembly 10, functional to the specific purpose of the system 1, namely, the collection of refuse, and a maximum power point tracker MPPT.

A control unit 40 of the system is outlined centrally. As shown, it is operatively connected to the one or more functional parts 16-19 and 31-38. The control unit 40 comprises a software module 41, in the form of a software chip. A program 42 is provided on the chip for control of the one or more functional parts 16-19, 31-38 of the refuse collection system by the control unit 40.

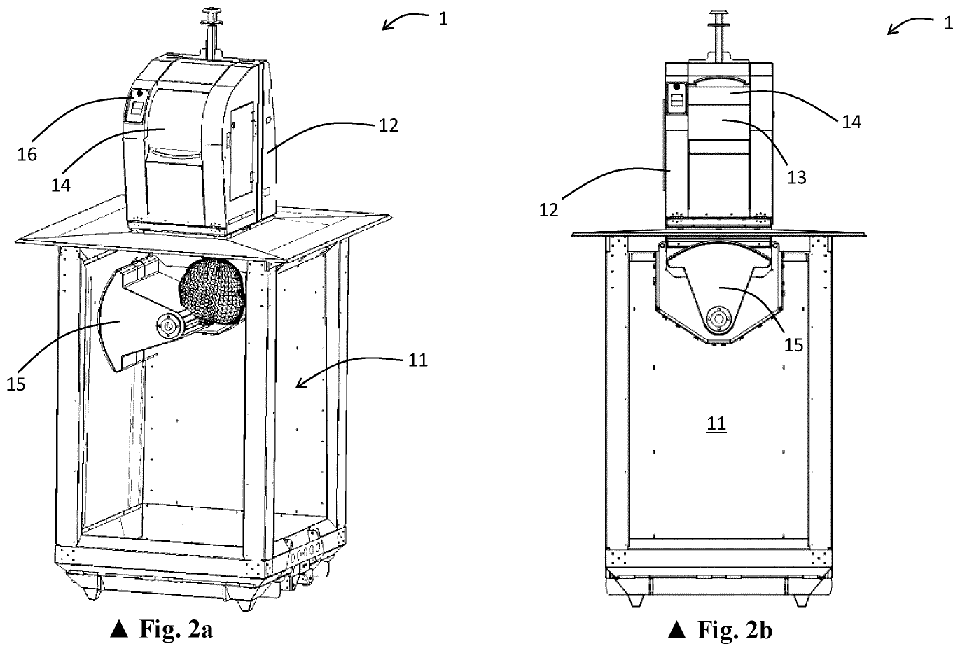

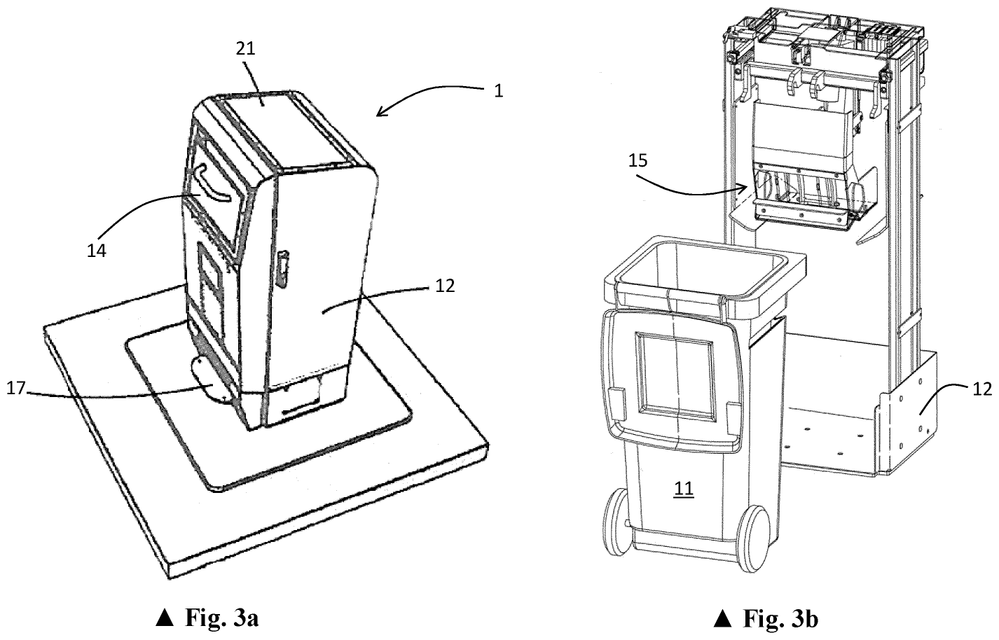

The refuse collection assembly 10 comprises a refuse collection container 11, and a housing 12. These may for example be in the physical form as in the embodiments shown in FIGS. 2a-b and 3a-b. The refuse collection container 11 is in the embodiment of FIGS. 2a-b embodied as an underground collection container. In the embodiment of FIGS. 3a-b the refuse collection container 11 is in the form of a top opening bin.

In both embodiments, the refuse collection assembly 10 has an introduction opening 13 in the housing 12 allowing a user to introduce refuse therein so that the introduced refuse drops into the container 11. A door 14 grants or blocks access to the introduction opening 13 by uncovering or covering the introduction opening 13. The uncovering and covering of the introduction opening 13 by the door 14 is driven by an electrically powered door actuator 17 of the refuse handling assembly 10, operative between the housing 12 and the door 14.

In the FIGS. 2a-b the front and right side wall of the underground collection container 11 are shown removed to expose the interior of the system 1. In FIG. 3b, the respective embodiment is shown with front, side and back walls removed, and the bin 11 being moved out of the housing 12, so that the interior is visible. In the interior of both systems a refuse handling device 15 is indicated, which is functional to provide a downwards force on refuse collected in the container 11 for counteracting expansion thereof. In the case of the embodiment of FIGS. 2a-b, the device 15 is both operable as a distribution device as well, for distribution of the refuse over left and right sides of the container 11, and as a compacting device, for decreasing the volume of the refuse in the container 11. In the embodiment of FIGS. 3a-b, the device 15 is operable only as a pressing element without the distribution functionality. The actions of the device 15 are in both embodiments driven by operation of an electrically powered handling device actuator 18 of the refuse handling assembly 10.

Both embodiments further comprise a user interface 16 as is known in the art, which is integrated in the housing 12.

The operation of the mentioned parts of the embodiments of FIGS. 2a-b and FIGS. 3a-b are disclosed in detail respectively in WO2021013555 and WO2019221605, even as possible further features thereof.

In both embodiments, the energy supply unit 20 comprises a photovoltaic panel 21, which are arranged at the exterior of the housing 12 for capturing solar irradiation, namely on a movable mounting element which is operable by electrically powered actuator 19 for adjusting an azimuthal and inclination angle of the photovoltaic panel for orienting these towards the sun. The energy supply unit 20 further comprises a battery 22, electrically connected to the photovoltaic panel 21 for being charged thereby. Although not shown in FIG. 1 for the sake of overview, the battery is also electrically connected to the functional parts 16-19, and 31-38 of the refuse collection system 1 which are involved with the collection of the refuse for supplying these functional parts 16-19, 31-38 with electrical energy. The energy supply unit also powers the control unit 40 and the parts 45, 46 of the MPPT.

The functional parts 31-36 of the group 30 are involved with a determination of actual states and conditions of the system 1 and the functional parts 37, 38 with data communication with devices external from the system 1, for example a remote server for data communication thereof with the control unit 40, or a user device for data communication thereof with the control unit 40 and/or a remote server e.g. via the control unit 40, e.g. via the user interface 16. Therein, parts 31-33 are sensors provided at the exterior of the device. Multiple temperature sensors 31 are configured and arranged for measuring the temperature of the photovoltaic panel 21, and the outdoor air. Sensor 32 is configured for measuring solar irradiation of the photovoltaic panel, and arranged proximate thereto with the irradiation capturing surface thereof being arranged flush with that of the panel. Sensors 33 are cameras and microphones for registering images and sounds. These include a camera and microphone for use in conjunction with the user interface 16, and a camera aimed at the photovoltaic panel for detecting objects and/or shadows on the irradiation capturing surface thereof, and for detecting visible factors that may be of influence on a maintenance state thereof, e.g. damages or signs of wear. Parts 34-36 are sensors provided at the interior of the device. Sensors 34 is force sensors, configured to provide an indication of the weight of received refuse through the introduction opening and of an exerted pressing force on the collected refuse in the container 11 by the handling device 15. Sensors 35 are presence detection and movement sensors configured to detect a received item and possible movement thereof, e.g. indicating this item being a living organism. Sensor 36 is a fill-level sensor for the container 11, e.g. of the ultrasonic or laser detection type. The sensors 31-38 of the group 30 are all operatively connected to the software module 41 for data communication of measurement values M₃₁ to M₃₆ produced by the sensors 31-36, and back and forth communication of data C₃₇ and M₃₈ with receiver 37 and transmitter 38, respectively.

According to the invention, the refuse collection system 1 further comprises maximum power point tracker MPPT. This MPPT comprises a DC-DC converter 45 which is electrically connected at a first output thereof to the photovoltaic panel 21 and at second output thereof to the battery 22, as shown in FIG. 1.

The maximum power point tracker MPPT is configured to increase the power output P₂₁ of the photovoltaic panels 21 towards, e.g. to set this power output P₂₁ to, the maximum power point MPP thereof, therein adjusting a current I₂₂ at which the batteries 22 are charged by the photovoltaic panels 21 via the DC-DC converter 45.

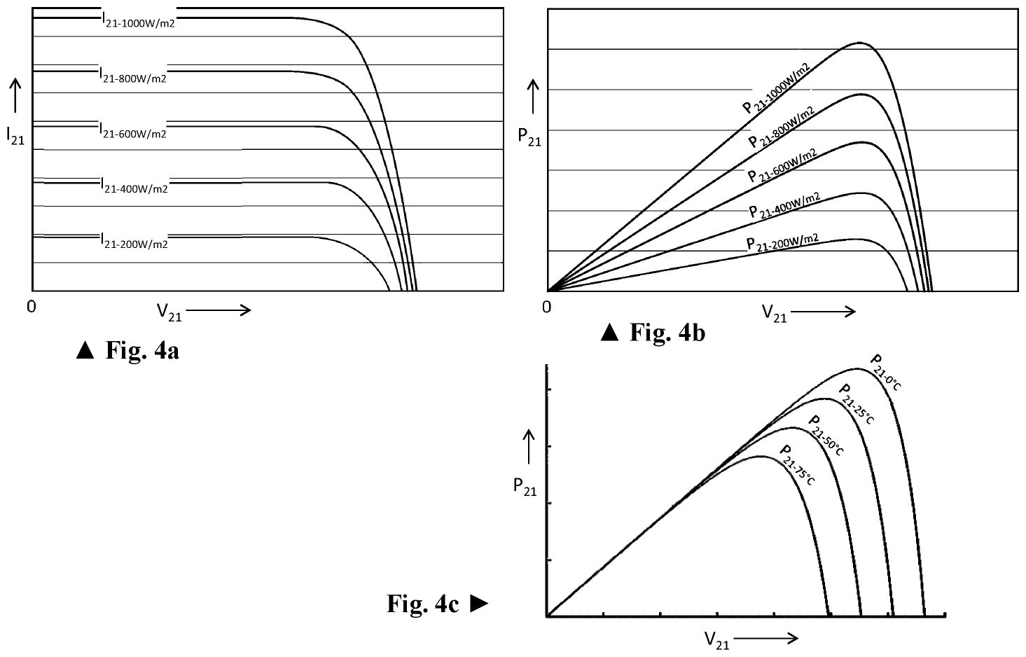

This may be envisaged from FIGS. 4a-c, which illustrate that the voltage-power curves are altered with changing conditions. These figures show typical curves for different values of the two most influential of these conditions on the curves, namely irradiation and temperature of the photovoltaic panel. Therein the condition is denoted in the subscript of the quantity plotted as a function of the voltage, in the form I_{21-[condition]}, and P_{21-[condition]}, e.g. I_{21-400W/m2} for the voltage-current curve at an irradiation level of 400W/m2, other conditions remaining constant, and P_{21-50° C.}, for the voltage-power curve at a panel temperature of 50° C. with other conditions remaining constant.

FIG. 4b shows that the voltage-power curves are stretched mainly in the power-dimension and slightly in the voltage-dimension with increasing irradiation. This involves a shift of the maximum power point of the panel 21, i.e. the top of the curve, in mainly the power dimension and slightly in the voltage dimension, wherein the MPP shifts to a higher power P₂₁ and a lower voltage V₂₁ as the irradiation increases.

FIG. 4c shows that the voltage-power curves shift in both the power-dimension and the voltage-dimension with increasing panel temperature. This involves a shift of the MPP in both dimensions, wherein the MPP shifts to a higher power P₂₁ and a higher voltage V₂₁ as the panel temperature increases.

The maximum power point tracking by the MPPT may involve adjustment of the current I₂₁ produced by the panel 21, which moves the operation of the panel 21 towards the MPP in the power dimension, or as is preferred, both the voltage V₂₁ and the current I₂₁, which moves the operation towards the MPP in both the voltage and the power dimension. For example, in an embodiment wherein the MPPT is a constant-voltage-MPPT, the MPPT maintains a constant voltage V₂₁ over the panel 21, so as to follow shifts of the MPP only in the power dimension. An embodiment wherein the MPPT is a dynamic MPPT, enables adjustment of the voltage V₂₁ as well, so as to be able to follow shifts of the MPP in both dimensions.

In an embodiment of the inventive system, the DC-DC converter 45 is configured for constant-voltage tracking. In an embodiment the DC-DC converter 45 is configured for tracking in both dimensions. In an embodiment all tracking of the MPPT is executed by the DC-DC converter 45, and the program 43 is not configured for MPP tracking at all.

In an embodiment the program 43 is configured for constant-voltage tracking in the voltage-dimension. In an embodiment the program 43 is configured for MPP tracking in the dimension of the power output P₂₁ or in both the dimensions. In an embodiment the DC-DC converter 45 is not configured for MPP tracking at all, and all tracking is executed by the program 43.

In the shown embodiment, the MPPT is advantageously fully integrated in the control unit 40. Such integration facilitates a convenient and robust connection to the software module 41. In other embodiments however, the MPPT may within the scope of the invention be partially or completely external from the control unit 40.

In the shown embodiment, the software module 41 of the control unit 40 is operatively connected to the DC-DC converter 45 and contains a program 43 for controlling the operation of the DC-DC converter 45 by the control unit 40. Such control may within the scope of the invention be merely in the simple form of switching the DC-DC converter on and off. However, in the shown embodiment, the program 43 contains an algorithm controlling the DC-DC converter such as to adjust both the voltage V₂₁ over and current I₂₁ produced by the photovoltaic panels, thus shifting the operation point of the panel 21 in both the dimensions of the power output P₂₁ and the voltage V₂₁. Therein it adjusts, indirectly, the charging current I₂₂ of the battery 22, whereto it executes the communication by the software module 41 of a signal C_{V21} indicative of a determined value of an adjusted voltage V₂₁ of the panel 21 to the DC-DC converter 45. For example, a command to adjust the imposed panel voltage V₂₁ to the determined value. Alternatively, it may for example determine and communicate the corresponding charging current I₂₂ to the DC-DC converter. Such alteration of the voltage V₂₁ and current I₂₁ may in particular be aimed at moving the operation of the panel 21 towards the MPP, however, may also be executed for other reasons-for example to obtain information on the actual voltage-current curve and/or voltage-power curve, and/or present conditions of the panel 21, in combination with measurements. For example, an actual voltage-power curve may by such alteration and simultaneous measurement of the current I₂₁ be determined over the entire, or a major part of, the voltage range of the panel 21 by the program 43 and stored in a memory portion 44 of the software module 41, e.g. for direct or later use in MPP tracking by the program 43. Or, multiple points of the actual voltage-power curve may be determined for comparison with stored curves at different conditions, to subsequently apply interpolation between known curves of which the determined points of the actual curve are determined to be in between. To provide measurement of the current I₂₁ of the panel 21, the MPPT in the shown embodiment comprises an ammeter 46, electrically connected to the photovoltaic panels 21, and configured for producing a signal M_{I21} indicative of the actual current I_{I21} produced by the photovoltaic panels 21. The ammeter 46 is operatively connected to the software module 41 of the control unit 40 for communicating the signal M_{I21} to the software module 41.

The program 43 contains an algorithm for determining the actual voltage-power curve in the described way, by means of repeated adjustments of the voltage V₂₁ to multiple voltages distributed over the at least part of, preferably the entire, voltage range of the panel 21, and measurement by the ammeter of the actually associated respective currents I₂₁. The power output P₂₁ actually associated with the respective voltages V₂₁ is determined by calculating the product of the voltages and the respective associated currents. These values are stored in association with one another in the memory portion 44 of the software module, and furthermore in association with the actual values of the conditions as measured by the sensors 34-46. In an example of this embodiment, the voltage-power curve is determined over the entire voltage range for 128 voltages at regular intervals.

The program 43 furthermore contains an algorithm for determining the actual voltage-power curve from stored values of voltage-power curves. These values both include values as determined from previous determinations of the voltage-power curves at other moments in time, and values of voltage-power curves from other resources, e.g. determined in test settings. These are also stored in association with values of conditions.

Therewith, the program 43 thus has two manners of determining the actual voltage-power curve. The program 43 furthermore has an algorithm for determining which manner of determining the actual is to be used in different situations. This depends on multiple factors. The first factor is formed by the actual conditions of the photovoltaic panel, as indicated by the sensors 34-36. The first mentioned manner is applied when the actual conditions are outside the range of the conditions for which the curves are stored in the memory portion 44, or when interpolation would have to take place between values that differ more than a reference value. The second factor is the charge level of the battery. The first manner is applied only when the charge level is above a reference value, as it requires more time and energy.

Other factors may in embodiments also be considered in the determination which manner to use and to which extent.

The actual voltage-power curve of the photovoltaic panels 21 is determined by the program 43 if triggered by multiple events or conditions. A first is the lapse of a period of time since the last determination of the actual voltage-power curve, which may for example be programmed as 30 or 60 minutes. A second is a change in the conditions of the photovoltaic panels 21 measured by the sensors 34-36, in case the change exceeds a reference value within a time period of a predetermined duration from the last determination of the actual voltage-power curve, for example a temperature change of more than one degree in thirty minutes from the last determination or an irradiation change of more than 10 W/m² in thirty minutes. The third is a detection by the camera 33 aimed at the panel 21 of a shadow being cast or an object being present on the capturing surface of the panel 21. The fourth is the dawning of a predetermined time of day, e.g. wherein the determination of the actual voltage-power curves is executed only during daytime, e.g. the daytime being stored in the memory portion 44 of the software module 41 based on the actual day of the year, or the daytime being detected based on a condition of the photovoltaic panels measured by the sensors 34-36, e.g. light intensity or irradiation. The triggering is furthermore dependent on a state of the system 1, for example a battery level.

The program 43 is operatively connected to the program 42 for exchange of data, e.g. variables. The program 42 is alike the program 43 operatively connected to the memory portion 44. The program 42 has multiple algorithms for attuning the control of the operation of the electrical functional parts 16-19, 31-38 of the system based on the actual values of voltage V₂₁, current I₂₁, power output P₂₁, and actual voltage-current and voltage-power curves.

The program 42 furthermore includes an algorithm for predicting energy availability, in the present and in the near future, based on these actual values and on the current curves. A few examples of algorithms are mentioned below:
Based on the mentioned actual values, a suitable operative power of for instance the actuator 18 of the handling device 15 is determined.
Based on the energy availability, a frequency of measurements by the sensors 31-36 is determined, and e.g. if below a certain, very low, reference level, the door actuator may be controlled such that the door 14 remain closed despite a user expressing via the user interface 16 a wish to drop refuse in the container 11, and the user interface 16 be controlled such that it produces a warning to the user that the system 1 is closed.
A low expected energy availability is also communicated to the transmitter 38 for being sent to the remote server.
When a curve is determined to be unusually low for the actual conditions and/or time of day, a detection of the presence of a shadow or object on the capturing surface of the panel 21 by the camera 33 on the panel 21 is triggered, and if detected, the actuator 19 may be controlled for removing the object or to redirect the panel 21 such that it is out of the shadow.

It is noted that whereas the illustrated embodiments implement a software module as part of the control unit, other configurations are possible for the control of the DC-DC conversion including the tracking. For example, circuitry may be provided instead of part of or the entire software programming. For example, any programming or circuitry may be external from the control unit, e.g. partly or entirely. For example, an operatively connected memory portion may be external from a software module, e.g. external from a control unit.

In embodiments, multiple control units may be provided, for example for control of functional parts and for control of the DC-DC conversion including the tracking.

In an embodiment, the actual current being generated by the one or more photovoltaic panels 21 is monitored by the control unit 40. This can be done by employing the ammeter 46 that is electrically connected to the photovoltaic panels 21 on the other side and communicatively connected to the control unit 40, configured for producing a signal M121 indicative of the actual current 121 produced by the photovoltaic panels 21, for communication to the control unit 40.

In an embodiment, the control unit 40 disables the maximum power point tracking, e.g. the tracker (MPPT), in case the actual current generated by the one or more photovoltaic panels 21 is below a threshold value so that the one or more batteries are then charged directly by the one or more photovoltaic panels 21 without involvement of the DC-DC converter of the MPPT. This approach, for example, can be of benefit in the situation that the actual current being generated by the photovoltaic panels 21 is less than the energy consumption of the MPPT itself. In this case, the direct charging of the batteries 22 without the use of the MPPT is more effective. For example, in a practical embodiment, the threshold value for the current is between 8 and 12 mA, e.g. 10 mA.

It is emphasized, that different arrangements and functionalities disclosed herein in relation with the discussed embodiments may be applied independently from one another in other embodiments.

1-34. (canceled)

35. A refuse collection system, comprising:
a refuse collection assembly, comprising:
a refuse collection container;
a housing, having an introduction opening allowing a user to introduce refuse therein so that the introduced refuse drops into the container; and
one or more electrically powered functional parts of the refuse collection system which are involved with the collection of the refuse;
an energy supply unit, comprising:
one or more photovoltaic panels, arranged for capturing solar irradiation, and producing a current at a voltage thereover; and
one or more batteries, electrically connected to the photovoltaic panels for being charged thereby,
wherein the energy supply unit is operatively connected to the one or more electrically powered functional parts for supplying these functional parts with electrical energy;
a control unit, operatively connected to the one or more functional parts and being programmed for control of the one or more functional parts of the refuse collection system by the control unit; and
a maximum power point tracker, comprising a DC-DC converter, the DC-DC converter being electrically connected at a first output thereof to the one or more photovoltaic panels, and at second output thereof to the one or more batteries,
wherein the maximum power point tracker is configured and connected to the batteries and photovoltaic panels for increasing the power output of the photovoltaic panels towards by adjusting the current produced by, and/or the voltage over, the solar panels towards the maximum power point, therein adjusting a current at which the batteries are charged by the photovoltaic panels via the DC-DC converter such that the current corresponds to the increased power output of the photovoltaic panels.

36. The refuse collection system according to claim 35, wherein the control unit is programmed to control the DC-DC converter.

37. The refuse collection system according to claim 35, wherein the maximum power point tracker is partially or entirely integrated in the control unit.

38. The refuse collection system according to claim 36, wherein the control unit further comprises a software module operatively connected to the DC-DC converter, and containing:
programming for the control of the one or more functional parts of the refuse collection system; and
programming for controlling the operation of the DC-DC converter by the control unit.

39. The refuse collection system according to claim 35, wherein the control unit is programmed to execute an algorithm controlling the DC-DC converter such as to adjust the voltage over and/or current produced by the photovoltaic panels, therein adjusting the charging current of the batteries.

40. The refuse collection system according to claim 35, wherein the control unit is programmed to execute an algorithm for determining a value of the voltage over the photovoltaic panels and/or of the charging current of the batteries that differs from the actual respective voltage and/or current and is involved with an increase of the power output of the photovoltaic panels, and
wherein the control unit, is programmed to, via the operative connection to the DC-DC converter, communicate the different value of the respective voltage and/or current to the DC-DC converter.

41. The refuse collection system according to claim 35, wherein the control unit is programmed to execute an algorithm for determining a value of the voltage over the photovoltaic panels and/or of the charging current of the batteries that differs from the actual respective voltage and/or current and is involved with an increase of the power output of the photovoltaic panels, and
wherein the control unit is programmed to control the DC-DC converter such as to adjust the voltage over the photovoltaic panels and/or the charging current of the batteries to the determined respective different value of the voltage and/or current.

42. The refuse collection system according to claim 35, wherein the control unit comprises the DC-DC converter, and
wherein the control unit is at a first output thereof electrically connected to the photovoltaic panels, via the first output of the DC-DC converter of the maximum power point tracker, and at a second output thereof connected to the batteries, via the second output of the DC-DC converter.

43. The refuse collection system according to claim 36, wherein the control unit comprises the DC-DC converter,
wherein the control unit is at a first output thereof electrically connected to the photovoltaic panels, via the first output of the DC-DC converter of the maximum power point tracker, and at a second output thereof connected to the batteries, via the second output of the DC-DC converter, and
wherein the maximum power point tracker further comprises the programming of the control unit for controlling the operation of the DC-DC converter.

44. The refuse collection system according to claim 35, wherein the system further comprises an ammeter, electrically connected to the photovoltaic panels, and being configured for producing a signal indicative of the actual current produced by the photovoltaic panels, for use by the control unit in the control of the system, and
wherein the control unit is programmed to monitor the actual current produced by the one or more photovoltaic panels.

45. The refuse collection system according to claim 44, wherein the programming comprises disabling the maximum power point tracking in case the actual current produced by the photovoltaic panels is below a threshold value so that the one or more batteries are then charged directly by the one or more photovoltaic panels without involvement of the DC-DC converter of the maximum power point tracker.

46. The refuse collection system according to claim 40, wherein the control unit comprises the DC-DC converter,
wherein the control unit is at a first output thereof electrically connected to the photovoltaic panels, via the first output of the DC-DC converter of the maximum power point tracker, and at a second output thereof connected to the batteries, via the second output of the DC-DC converter,
wherein the maximum power point tracker further comprises the programming of the control unit for controlling the operation of the DC-DC converter,
wherein the maximum power point tracker comprises an ammeter, and
wherein the determination of the different value of the voltage and/or current by the algorithm in the software module is based on the measured current.

47. The refuse collection system according to claim 40, wherein the algorithm for determining the different value of the voltage over the photovoltaic panels and/or of the charging current comprises determining from a voltage-power curve of the photovoltaic panels over at least a part of the voltage range thereof, the different value of the voltage as the voltage which corresponds to the highest power output of the curve, and the different value of the voltage corresponds to the voltage at the maximum power point of the photovoltaic panels.

48. The refuse collection system according to claim 41, wherein the algorithm for determining the different value of the voltage over the photovoltaic panels and/or of the charging current comprises determining from a voltage-power curve of the photovoltaic panels over at least a part of the voltage range thereof, the different value of the voltage as the voltage which corresponds to the highest power output of the curve, and the different value of the voltage corresponds to the voltage at the maximum power point of the photovoltaic panels, and
wherein the determination of the actual voltage-power curve of the photovoltaic panels by the algorithm in the software unit comprises the following steps:
1) controlling the DC-DC converter such as to adjust the voltage over the photovoltaic panels;
2) determining the power output at the adjusted voltage by multiplying the value of the adjusted voltage with the measured value of the current produced by the photovoltaic panels at the adjusted voltage communicated to the software module by the ammeter;
3) storing the value of the power output in association with the value of the adjusted voltage; and
4) repeating the steps 1), 2) and 3) such that multiple values of the power output are stored in association with values of voltages distributed over the at least a part of the voltage range of the photovoltaic panels.

49. The refuse collection system according to claim 48, wherein the control unit has stored therein voltage-power curves of the photovoltaic panels for different respective conditions of the photovoltaic panels which have an influence on the voltage-power relationship of the photovoltaic panels, each voltage-power curve being stored in the form of data on values of the power output in association with values of voltages over the photovoltaic panels distributed along the voltage range of the voltage-power curve, and
wherein the system further comprises one or more sensors, each of the one or move sensors being configured for producing a respective signal indicative of one or more of the actual conditions of the photovoltaic panels, and being operatively connected to the control unit for communicating the signal to the control unit.

50. A control unit for a refuse collection system,
the refuse collection system comprising an energy supply unit comprising:
one or more photovoltaic panels; and
one or more batteries, electrically connected to the photovoltaic panels for being charged thereby,
wherein the energy supply unit is operatively connected to one or more electrically powered functional parts of the refuse collection system which are involved with the collection of the refuse for supplying the functional parts with electrical energy,
wherein the system further comprises a maximum power point tracker comprising a DC-DC converter, the DC-DC converter being electrically connected at a first output thereof to the one or more photovoltaic panels, and at second output thereof to the one or more batteries, wherein the maximum power point tracker is configured and connected to the batteries and photovoltaic panels for increasing the power output of the photovoltaic panels towards the maximum power point thereof, by adjusting the current produced by, and/or the voltage over, the solar panels towards the maximum power point, therein adjusting a current at which the batteries are charged by the photovoltaic panels via the DC-DC converter such that it corresponds to the increased power output of the photovoltaic panels, and
wherein the control unit is configured for operative connection to the one or more functional parts and to the DC-DC converter, and is programmed:
for control of the one or more functional parts of the refuse collection system by the control unit; and
for controlling the operation of the DC-DC converter.

51. The control unit according to claim 50,
further comprising a software module, containing:
programming for control of the one or more functional parts of the refuse collection system by the control unit; and
programming for controlling the operation of the DC-DC converter,
wherein the software module is configured for operative connection to the functional parts and to the DC-DC converter.

52. The control unit according to claim 50, wherein the control unit is programmed to monitor the actual current produced by the one or more photovoltaic panels via an operative connection to an ammeter which is electrically connected to the photovoltaic panels, and configured for producing a signal indicative of the actual current produced by the photovoltaic panels.

53. The control unit according to claim 52, wherein the programming comprises disabling the maximum power point tracking in case the signal indicates that the actual current produced by the photovoltaic panels is below a threshold value so that the one or more batteries are then charged directly by the one or more photovoltaic panels without involvement of the DC-DC converter of the maximum power point tracker.

54. A method for powering a refuse collection system, comprising:
providing an energy supply unit comprising one or more photovoltaic panels, and one or more batteries, electrically connected via a DC-DC converter to the photovoltaic panels for being charged thereby;
charging the one or more batteries by the photovoltaic panels;
supplying the one or more functional parts of the refuse collection system which are involved with the collection of the refuse with electrical energy by means of the energy supply unit; and
providing maximum power point tracking,
wherein the maximum power point tracking increases via the DC-DC converter, the power output of the photovoltaic panels towards the maximum power point thereof, by adjusting the current produced by, and/or the voltage over, the solar panels towards the maximum power point, therein adjusting a current at which the batteries are charged by the photovoltaic panels via the DC-DC converter such that the current corresponds to the increased power output of the photovoltaic panels.
